(19) United States
(12) Patent Application Publication
(10) Pub. No.: US 2026/0016279 A1
(43) Pub. Date: Jan. 15, 2026

(54) Measuring device for characterising a measurement object in a vacuum using an inductive sensor in electromagnetic transmission

(71) Applicant: SURAGUS GmbH, Dresden (DE)

(72) Inventors: Marcus Klein, Dresden (DE); Florian Koch, Bad Berka (DE)

(73) Assignee: SURAGUS GmbH, Dresden (DE)

(21) Appl. No.: 19/260,715

(22) Filed: Jul. 7, 2025

(30) Foreign Application Priority Data
Jul. 9, 2024 (DE) 10 2024 119 448.0

(51) Int. Cl. G01B 7/06

(52) U.S. Cl. CPC G01B 7/10

(57) ABSTRACT

A measuring device for characterizing a measurement object in a vacuum includes at least one inductive sensor having at least one transmitting coil for generating an alternating electromagnetic field, a receiving coil for detecting an impedance change, and a signal amplifier and/or a signal processing unit for evaluating measurement signals. The measuring device can be integrated in a vacuum system with minimal additional space requirements and enables a measurement with high accuracy and high spatial resolution with precise repeatability on a static measurement object and/or a measurement object guided past the measuring device. Both the transmitting and receiving coils as well as the signal amplifier and/or the signal processing unit are arranged outside a vacuum region. The transmitting and receiving coils can each be inserted into a capsule, and the capsules are configured as an integral part of a chamber wall of a vacuum chamber and project into the vacuum.

### CROSS-REFERENCE TO RELATED APPLICATION

This application claims the benefit of German Patent Application DE 10 2024 119 448.0, filed on Jul. 9, 2024, the contents of which is incorporated by reference in its entirety.

### TECHNICAL FIELD

The invention relates to a measuring device for characterizing a measurement object in a vacuum. The measuring device comprises at least one inductive sensor that has at least one transmitting coil for generating an alternating electromagnetic field and a receiving coil for detecting an impedance change, as well as a signal amplifier and/or a signal processing unit for evaluating the measurement signals.

### BACKGROUND

Inductive sensors include eddy current sensors. Eddy current sensors are inductively acting sensors that can be used both with and without contact. Their measuring principle is based on the fact that an alternating current is applied to a transmitting or induction coil in a sensor head of the eddy current sensor, thus generating an alternating electromagnetic field or primary field. The primary field induces eddy currents in a measurement object to be characterized. The eddy current flowing in the measurement object generates an electromagnetic secondary field which is opposite the primary field generated by the coil and thus influences the total field formed by the primary field and the secondary field. The change in the total field can be detected by means of inductive sensors, e.g. a coil. The field changes depend, for example, on the material as well as on the position of the measurement object in the overall field or on the volume of the material of the measurement object. The field changes are used to draw conclusions regarding the material properties and/or the volume and/or position of the measurement object.

Eddy current sensors can be provided in different coil arrangements or geometries, e.g. in transmission geometry, wherein the measurement object to be characterized is arranged between a transmitting and a receiving coil, or in reflection geometry or semi-transmission geometry, wherein the transmitting and receiving coils are arranged on the same side of the measurement object. When using reflection geometry, the transmitting coil and the receiving coil can be provided separately from each other or formed integrally with each other. Use as an absolute coil is also possible, meaning that a single coil functions as both the transmitting coil as well as the receiving coil. All sensors that operate in reflection are usually highly distance-sensitive and are often used as presence sensors or distance sensors.

Eddy current sensors are used for layer characterization in various industries, including the semiconductor industry. These sensors consist of at least one coil as well as electronics close to the coil for signal amplification. Systems for measuring layers outside of vacuum chambers are known, either as tabletop systems or freestanding systems. Measurements in a vacuum in large glass and film coating systems are also known. Here, one or more sensors including preamplifier electronics are integrated in the vacuum. Due to the space requirements, these have always been quite large vacuum chambers which provide sufficient space for the sensors. The possible applications in (high) vacuum cluster tools are limited since none of the solutions known to date meet the requirements for space, temperature and (high) vacuum. Rather, the current state of the art regarding layer characterization concepts in the semiconductor industry is based on ex-situ measurements using contacting four-tip measurements, which are only carried out hours or days after the coating process. This technology requires extensive logistics for so-called test wafers which serve as reference wafers for the process to be characterized, i.e. the product wafers to be characterized, and which must either be disposed of or recycled in a complex process, e.g. etched back, after measurement. The use of test wafers has a number of disadvantages. For example, system capacity is lost when test wafers are processed, process errors only become known after hours or days, and there is no 100% control over the process because only random measurements are possible. Another disadvantage is that it is assumed that test wafers are representative of product wafers, but test wafers often behave differently than product wafers because they often have different thermal masses, and warpage effects influence the process results. Warpage is understood to be the deformation or curvature of the wafer substrate, which means that the wafer is no longer flat but curves or bends in a certain direction.

(High and ultra-high) vacuum processing systems avoid the integration of electronics in a vacuum to prevent contamination and outgassing. In addition, vacuum chambers are volume-optimized and therefore built very compact in order to minimize long pumping times. Eddy current sensors for measuring nanometer-thin layers place considerable technical demands on the measurement setup. For example, complex signal processing is required, combined with high computing power which generates considerable heat. In a vacuum, heat dissipation is limited in comparison to measurement setups at atmospheric pressure since heat can only be dissipated via radiation. Thermal drifts therefore distort the measurement results. Ideally, all measurement instrumentation is therefore positioned outside the vacuum. For example, optical sensors measure through glass windows. However, the use of optical sensors for layer characterization is limited to optically transparent layers. For the measurement of opaque metal layers within a system, currently only the use of the above-mentioned test wafers remains, which are characterized outside the coating chamber and outside of the vacuum. For evaporation systems, quartz crystals are usually coated for layer thickness measurement. This is an indirect method that takes place at a reference location with different coating rates and has various disadvantages. In addition to the need to use correction factors, the quartz crystal must be replaced or cleaned. Furthermore, the method can only be used if the quartz crystal can be coated in a comparable manner without leaving a shadow on the substrate. This is largely not the case in cluster systems that deposit metal layers.

Therefore, eddy current sensors have not yet been used for material or layer characterization in (high) vacuum cluster tool process chambers in the semiconductor industry. In addition to the reasons mentioned above, there are also many integration problems in existing systems. For example, existing feedthrough arrangements in vacuum chambers are often unsuitable for the integration of measurement instrumentation; compact vacuum chambers lack space for additional measurement instrumentation so that there are no flexible positioning options.

Direct layer resistance measurement or metal thickness measurement in a vacuum chamber would be very advantageous, but with familiar eddy current sensors, it is not possible to create sufficient space for the passing of test samples since the working distance is only a few hundred micrometers to a few millimeters. This is impractical in a production environment since vibrations, movements and oscillations of a wafer handler, for example, can lead to collisions. The slightest positional deviations lead to measurement errors. Modern wafer handling modules transport two wafers simultaneously, one above the other (in two levels), making measurement with conventional sensors structurally impossible. EP 0 337 253 A2 describes a device for measuring the conductivity of materials. The measurement is carried out in a vacuum, and the measurement object to be characterized is positioned at a distance of 2 mm to 5 mm between the measuring coils since the measuring coils do not offer a larger working distance. Therefore, sensors with a large working distance and the largest possible distance tolerance are required.

A further challenge is that, for example, sputtered layers are often hot, and they would heat the temperature-sensitive eddy current sensors, which has a very negative impact on measurement accuracy and also the comparability of measurement results, as described above. Measuring at a large distance of more than 5 mm to 10 mm or even 50 mm, depending on the system conditions, greatly reduces the thermal radiation acting in the vacuum and thus the heating of the sensor. This would achieve higher measurement accuracy and is therefore desirable. Sensors that are distance-tolerant and can measure precisely at large distances, preferably more than 10 mm to 50 mm, are not yet known.

### SUMMARY

The present application provides a measuring device which can be integrated with minimal additional space requirements, with little or no outgassing in a (high) vacuum system in a defined position and with a defined distance tolerance to the test object and thus enables a measurement with high repeatability and accuracy on a static object and/or a measurement object moved past the measuring device.

In a first variant, the measuring device for characterizing a measurement object in a vacuum comprises at least one inductive sensor that has at least one transmitting coil for generating an alternating electromagnetic field and a receiving coil for detecting an impedance change, as well as a signal amplifier and/or a signal processing unit for evaluating the measurement signals. Both the transmitting and receiving coils as well as the signal amplifier and/or the signal processing unit are arranged outside a vacuum region, wherein the transmitting and receiving coils can each be inserted into a capsule, and the capsule is formed as an integral part of a chamber wall of a vacuum chamber and projects into the vacuum, wherein the chamber wall separates the vacuum region from an atmospheric side. The capsule is a component of the measuring device.

The advantage of this two-part design of the measuring device is that, thanks to the capsules arranged in the chamber wall, the entire measuring device, comprising the transmitting and receiving coils of an inductive sensor, in particular an eddy current sensor, as well as the complete signal processing, is positioned outside the vacuum. The capsules, one for the transmitting coil and one for the receiving coil, project into the vacuum, allowing the coils to be brought close to the measurement location. The electromagnetic field of the eddy current sensor acts directly through the capsules, and thus enables measurement when the components of the measuring device are arranged completely outside the vacuum. This supports the purity of (ultra-high) vacuum processes. It also allows the sensor to be replaced without having to interrupt the vacuum.

Furthermore, this avoids placing heat-generating components such as the signal amplifier and/or the signal processing unit, or potentially outgassing parts, into the vacuum, while simultaneously saving space in the vacuum chamber. By means of suitable signal processing, including filters and FPGAs, interference that occurs due to the structural distance between the sensor coils and the signal processing can be eliminated/corrected.

In a second variant, the measuring device for characterizing a measurement object in a vacuum comprises at least one inductive sensor that has at least one transmitting coil for generating an alternating electromagnetic field and a receiving coil for detecting an impedance change, as well as a signal amplifier and/or a signal processing unit for evaluating the measurement signals. The transmitting and receiving coils are each formed encased in a vacuum-compatible material and arranged within the vacuum region, and the signal amplifier and/or the signal processing unit are arranged outside a vacuum region, wherein the encased transmitting and receiving coils are each connected to the signal amplifier and/or the signal processing unit on an atmospheric side via a flange or a seal via a chamber wall of a vacuum chamber, wherein the transmitting and receiving coils have a spatial distance of 10 mm, preferably of up to 100 mm, from one another. The chamber wall separates the vacuum chamber from the atmospheric side.

The transmitting and receiving coils are each formed encased in a vacuum-compatible material and form a sensor head that is located within the vacuum. A vacuum-compatible material is a material that has little or no interaction with the vacuum or influence on the vacuum in the interior of the vacuum chamber. The sensor head is integrated vacuum-tight in the chamber wall of a vacuum chamber via a flange or seal so that the signal amplifier and/or the signal processing unit can be connected to the sensor head outside the vacuum chamber. The advantage is that this solution also avoids placing heat-generating or temperature-sensitive components, such as the signal amplifier and/or signal processing unit, or potentially outgassing parts, into the vacuum, while simultaneously saving space in the vacuum chamber. By means of suitable signal processing, including filters and FPGAs, interference that occurs due to the structural distance between the sensor coils/sensor head and the signal processing can be eliminated/corrected.

In one embodiment of the measuring devices, the inductive sensor is configured in a transmission geometry, wherein the transmitting coil is formed above and the receiving coil below the measurement object to be measured or vice versa. It is also possible to arrange sensor elements above and below the measurement object to be measured, which are configured as both a transmitting coil as well as a receiving coil.

The advantage of the transmission geometry arrangement is that it allows for large distances from the measurement object of up to 50 mm. The distance specification is usually half the distance between the transmitting and receiving coils, i.e. the two sensor heads and tips. At the same time, the positioning tolerance increases with the amount of the distance. The transmission approach is therefore particularly suitable when large distances are useful or necessary. This can be the case with hot measurement objects or when there is a high degree of automation. For the transmission geometry, the transmitting and receiving coils are arranged separately from one another and opposite one another and can each be inserted either into a capsule integrated in the chamber wall or can each be encased per se in a vacuum-compatible material in the vacuum chamber, and are each electrically connected to the signal amplifier and the signal processing unit via a seal or a flange on the atmospheric side.

In another embodiment of the measuring devices, the measurement object to be measured can be measured contactlessly, wherein the inductive sensor measures the measurement object in electromagnetic transmission during a movement of the measurement object to be measured past the inductive sensor and/or statically on the measurement object.

The alternating electromagnetic field or primary field generated in the transmitting or primary coil induces eddy currents in the measurement object to be characterized. These create an electromagnetic secondary field which is opposite the primary field generated by the coil and thus influences the total field formed by the primary field and the secondary field. This can be detected both in a measurement object moving past as well as statically on a measurement object. The impedance or impedance change of the receiving or measuring coil detected by the signal processing unit can be used to draw conclusions about either electrical or mechanical or geometric properties of the measurement object to be analyzed. For the electrical characterization of a deposited layer on a measurement object to be analyzed, for example, the layer resistance can be determined from the measurement signals. For a mechanical characterization of, for example, a deposited layer on a measurement object to be analyzed, the layer thickness of the measurement object can be determined from the measurement signals.

In a further embodiment of the measuring devices, the measurement object to be characterized can be guided past the capsules or the enclosed transmitting and receiving coils at a distance of 5 to 25 mm, preferably up to 50 mm. This provides sufficient space for the measurement object to be characterized to move past. At the same time, the positioning tolerance increases with the distance. Large distances are particularly necessary for hot measurement objects or when there is a high degree of automation and enable the measurement.

In a further different embodiment of the measuring devices, the capsules projecting into the vacuum region are formed of a non-conductive and non-outgassing material in accordance with the first variant of the measuring device, or the transmitting and receiving coils are encased with a non-conductive and non-outgassing material according to a second variant of the measuring device. This further supports the purity of (ultra-high) vacuum processes. Such materials can be, for example, PEEK (polyetheretherketone) and other low-outgassing plastics. The capsule must be non-conductive at least at the tips, otherwise no measurement through the capsule is possible.

In one embodiment of the measuring devices, the measuring device is arranged in a separate measuring chamber which can be connected to a process chamber or handling chamber in which the measurement object to be measured can be processed, either in a first variant of the measuring device via the capsules as part of the measuring device or in a second variant of the measuring device via a flange or a seal, and the measurement object to be measured can be transferred from the process or handling chamber into the measuring chamber via a handling system without interrupting the vacuum and can be measured there.

The advantage of this embodiment is that the measuring chamber can be individually connected to a free position in a processing system easily and without great effort. Many connections to processing systems are standardized. Sometimes not all positions in a processing system are occupied. This makes it very easy to integrate the measuring chamber as a separate module, depending on the process. At the same time, it offers the same advantages as the arrangement directly in the process chamber, as described above.

In another embodiment of the measuring devices, the measuring device is formed in a 5 to 75 mm thick, preferably 15 mm thick intermediate module which is arranged between the process chamber and a handling region, wherein the intermediate module is formed as a 220 mm to 4500 mm wide frame in which the transmitting and receiving coils of the measuring device are formed so that a measurement object to be measured can be moved past the transmitting and receiving coil of the inductive sensor at a distance of 2 mm to 50 mm during a transfer into or out of the process chamber into the handling region. The size of the frame is appropriately designed for 200- or 300-mm wide wafers to pass through. The concept is also useful for larger panels that are 500 to 4500 mm in size. The embodiment as an intermediate module for cluster systems has the advantage that very few changes to the system have to be made since no electrical or physical feedthroughs have to be added. Only the range of the handler or transport system needs to be extended by the thickness of the intermediate module. In the first variant of the measuring device, the capsule for accommodating the transmitting coil and the capsule for accommodating the receiving coil are integrated in the intermediate module. In the second variant of the measuring device, the transmitting and receiving coils are each integrated in the intermediate module via a seal or a flange. In both variants, the measurement object to be measured can be moved past the measuring device without having to interrupt the vacuum. Replacement, maintenance and/or repair of the measuring device is also possible without interrupting the vacuum.

In a further embodiment of the measuring devices, the respective measuring device is arranged integrated in or on a chamber valve which separates the process chamber and the handling region from each other. Here, too, the eddy current sensor measures through a non-conductive capsule or through the direct encapsulation of the transmitting and receiving coil. Either a capsule projecting into the vacuum chamber is integrated in or next to the chamber valve, or the encased sensor head with the transmitting and receiving coil is integrated in or next to the chamber valve. The first variant of the measuring device has the advantage that no part of the sensor is positioned in the vacuum. This supports the purity of (ultra-high) vacuum processes. It also allows the sensor to be replaced without having to interrupt the vacuum. In the second variant of the measuring device, the heat-generating components, such as the signal amplifier and/or the signal processing unit, are arranged outside the vacuum and do not negatively influence the measurement results.

In a further different embodiment of the measuring devices, more than one measuring device according to claims 1 to 9 is formed next to one another in a row. This embodiment is particularly suitable for applications in inline vacuum coating systems, for example, for glass coating with a width of up to 4500 mm. For this purpose, a plurality of the measuring devices are arranged next to one another in rows in order to be able to measure a measurement object to be measured across its entire width. Either the multiple measuring devices are arranged in a separate measuring chamber, or the multiple measuring devices are arranged next to one another within an intermediate module, or the multiple measuring devices are arranged in and next to a chamber valve.

In one embodiment of the measuring device, a second sensor, in particular a temperature sensor, is arranged in the immediate vicinity of the inductive sensor, wherein values of a layer resistance of the measurement object can be determined by means of the inductive sensor, and temperature values of the measurement object can be determined by means of the temperature sensor, wherein a prediction of a cold resistance of the measurement object and of temperature-independent layer thicknesses of the measurement object can be calculated from the determined values of the layer resistance and the temperature values of the measurement object. This allows further process parameters, in particular the temperature, to be detected. This temperature sensor is therefore used to make a prediction of the cold resistance of hot-measured layers on the measurement object and to subsequently back calculate the correct metal thickness.

In summary, the measuring device has the following advantages: The measurement can be carried out contactlessly and directly on a process wafer, in particular on a productive wafer or wafer-like substrate as the measurement object. This enables real-time monitoring of each individual process wafer. Dedicated test wafers are therefore no longer absolutely essential so that system time can be used for production wafers instead of test wafers, and operating costs can ultimately be reduced. Material costs for test wafers and the separate testing process are also saved. Furthermore, it is therefore possible to obtain direct feedback on the current process immediately after the measurement of test wafers, rather than after hours or days. In addition, the measurement can be carried out without interrupting the vacuum, which thereby also allows process time to be saved for pumping out the process chambers and allows better, more immediate measurement results to be achieved. It is also possible to measure immediately before and immediately after a layer deposition process. This allows conclusions to be drawn about the quality, e.g. the (remaining) service life of a coating target.

The present disclosure further addresses the space constraints within a vacuum chamber, as well as the requirement to integrate as few electronic components (outgassing) into the vacuum as possible.

This makes it possible to measure directly after deposition in a vacuum chamber and to determine the metal thickness or layer resistance of non-transparent layers on both test and production wafers just a few seconds or minutes after the coating process. Advantageously, it is no longer necessary to eject test wafers and subsequently measure them on offline tools (ex-situ) outside of the vacuum.

On account of the large distances between the transmitting and receiving coil(s), collision-free operation is possible even when there are vibrations, or measurement on two-tier handling systems.

### BRIEF DESCRIPTION OF THE DRAWINGS

The invention will be explained in more detail below by exemplary embodiments.

FIG. 1 shows the measuring device in accordance with a first variant.

FIG. 2 shows the measuring device in accordance with the first variant in connection with and use in a vacuum chamber.

FIG. 3 shows the measuring device in accordance with a second variant;

FIG. 4 shows the arrangement of the measuring devices in accordance with a first or second variant in an intermediate module.

FIG. 5 shows the arrangement or integration of the measuring devices on or in a chamber valve.

FIG. 6 shows the embodiment of the measuring devices from FIG. 4 with multiple measuring devices arranged next to one another.

FIG. 7 shows the arrangement or integration of the measuring devices at different positions in a vacuum chamber or vacuum system.

### DETAILED DESCRIPTION

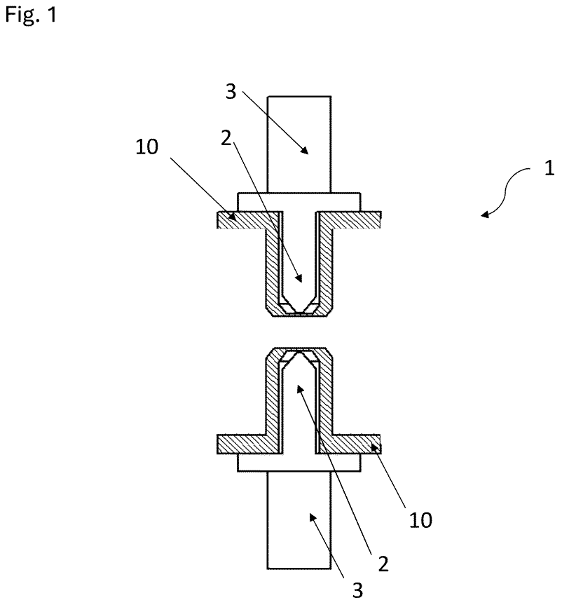

FIG. 1 shows the measuring device 1 in a first variant. The measuring device 1 comprises at least one inductive sensor which has at least one transmitting coil 2 for generating an alternating electromagnetic field and a receiving coil 2 for detecting an impedance change, as well as a signal amplifier and a signal processing unit 3 for evaluating the measurement signals, and at least one capsule 10 into which the transmitting and/or receiving coil 2 can be inserted. The transmitting and receiving coils 2 are each arranged in a capsule 10, wherein the transmitting and receiving coils 2 are configured to be insertable into the capsule 10 and replaceable. The measuring device 1 in FIG. 1 is designed for electromagnetic transmission measurement, wherein the measurement object to be measured is moved between the capsules 10 arranged at the top and at the bottom or is measured statically between the capsules 10. It is also possible to measure in reflection mode, in which case the transmitting and receiving coils 2 are located within a capsule 10, and the measurement object is measured from one side.

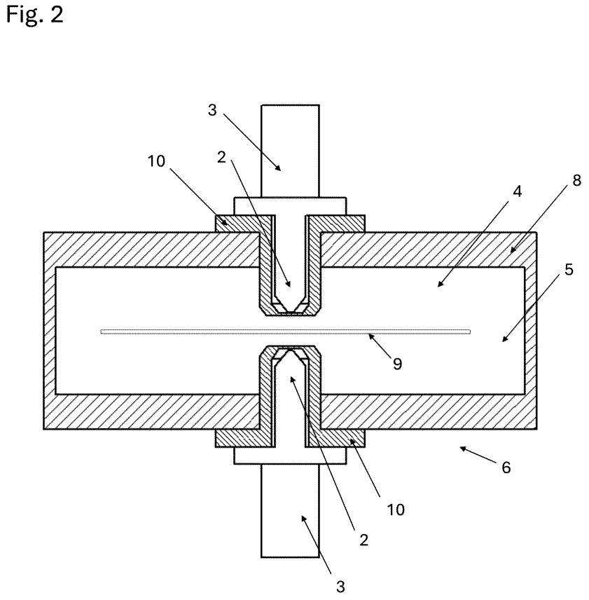

FIG. 2 schematically shows the measuring device 1 in a first variant installed in a vacuum chamber 4. The capsules 10 are an integral part of a chamber wall 8 which separates a vacuum region 5 from an atmospheric side 6. The coils 2 as well as all processing electronics, such as signal amplifiers and/or the signal processing unit 3, are directly connected to one another and positioned outside the vacuum region 5. The capsule 10 separates the sensor from the vacuum, wherein the sensor measures through the non-conductive capsule material. The capsule must be non-conductive at least at the tips, otherwise no measurement through the capsule is possible. The embodiment of the measuring device as a capsule module has the advantage that no part of the sensor is positioned in the vacuum. This supports the purity of (ultra-high) vacuum processes. It also allows the sensor to be replaced without having to interrupt the vacuum.

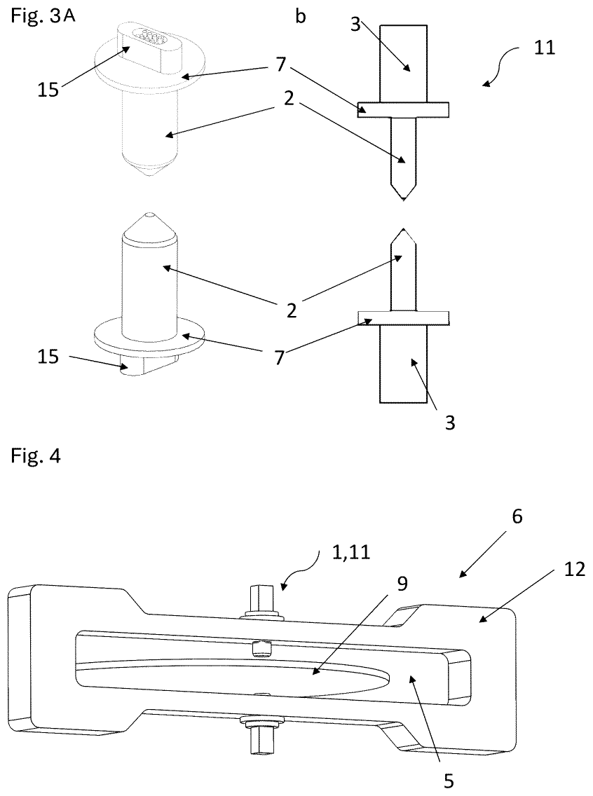

FIG. 3 shows the measuring device 11 in a second variant-in a perspective view in FIG. 3a as well as in a sectional view in FIG. 3b. The measuring device 11 comprises at least one inductive sensor having at least one transmitting coil 2 for generating an alternating electromagnetic field and a receiving coil 2 for detecting an impedance change, as well as a signal amplifier and/or a signal processing unit 3 for evaluating the measurement signals. The transmitting and receiving coils 2 are each formed encased in a vacuum-compatible material, i.e. they are enclosed in a non-conductive and non-outgassing material and form a sensor head. This sensor head 2 is arranged via a flange or a seal 7 in a chamber wall of a vacuum system (not shown) within the vacuum region of the vacuum chamber. The signal amplifier and/or the signal processing unit 3 are arranged outside a vacuum region (not shown). The sensor head has a connection point 15 with which the transmitting and receiving coils 2 can be connected to the signal amplifier and/or the signal processing unit 3 on an atmospheric side. The sectional view in FIG. 3b shows the signal processing unit 3 in connection with the sensor head. The perspective view in FIG. 3a shows the connection point 15. The eddy current sensor detects the signal changes caused by the measurement object located in the alternating electromagnetic field and forwards them to the signal processing unit 3 outside the measuring chamber 4, where the evaluation takes place. The field changes are used, for example, to draw conclusions about the material properties of a layer or a layer system of the measurement object to be analyzed. The measurement object can be, for example, a wafer. The advantage of this second variant of the measuring device 11 is that it avoids having to place heat-generating components, such as the signal processing unit 3, in the vacuum so that space can be saved in the vacuum chamber. The measuring device 11 in FIG. 3 is designed for an electromagnetic transmission measurement, wherein the measurement object to be measured is moved between the sensor head arranged at the top and at the bottom or can be measured statically therebetween. It is also possible to measure in reflection, in which case the transmitting and receiving coils 2 are located on one side of the measurement object, and it is measured.

FIG. 4 shows a further embodiment of the measuring device 1, 11. The measuring device 1, 11 is arranged or formed in an intermediate module 12. An intermediate module 12 is understood to be a module that separates a process chamber (not shown), in which a measurement object to be measured is processed, and a handling region. The intermediate module 12 is formed as a 220 mm to 4500 mm wide frame in which the transmitting and/or receiving coil 2 of the measuring device 1, 11 is formed so that a measurement object 9 to be measured can be moved past the transmitting and/or receiving coil 2 of the inductive sensor at a distance of 2 to 20 mm, preferably at a distance of 2 to 50 mm, during a transfer into or out of the process chamber into the handling region. The size of the frame is appropriately designed for 200 or 300 mm wafers or panels up to 4500 mm to pass through. The embodiment as an intermediate module 12 for cluster systems has the advantage that very few changes to the system have to be made, since no electrical or physical feedthroughs have to be added. Only the range of the handler needs to be extended by the thickness of the intermediate module 12. In accordance with the first variant of the measuring device 1, the transmitting and receiving coils 2 can each be formed in a capsule 10, wherein the capsule 10 is formed as an integral part of the intermediate module 12, or the coils 2 can be formed in accordance with the second variant of the measuring device 11 so as to be formed encased in a vacuum-compatible material, wherein they are connected to the signal amplifier and/or the signal processing unit 3 on the atmospheric side via a flange or a seal 7 in the intermediate module 12.

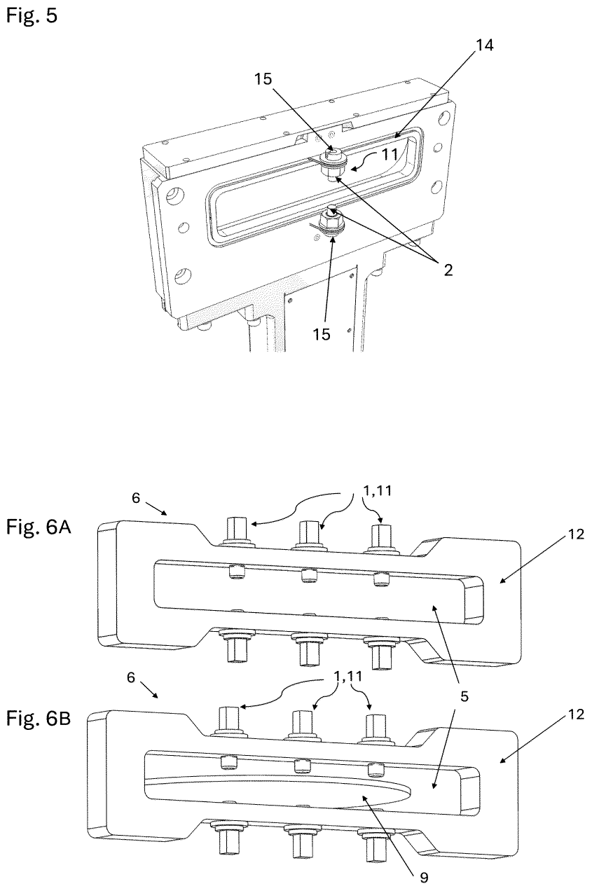

FIG. 5 shows a further embodiment of the measuring device 11. The measuring device 11 is arranged integrated in a chamber valve 14 which separates the process chamber (not shown) and the handling region (not shown) from each other. Here, the transmitting and receiving coils 2 encased in a vacuum-compatible material are positioned within the vacuum, and the measuring electronics 3 are positioned outside the vacuum region.

FIG. 6 shows an embodiment of the measuring device 1, 11 from FIG. 4. For large-area measurement objects 9 to be measured such as wafers or glass substrates or panels, it is sometimes necessary to be able to measure at multiple different locations at the same time. For this purpose, a plurality of the measuring devices 1, 11 are arranged next to one another in rows in order to be able to measure a measurement object 9 (shown in FIG. 6b) across its entire width. FIG. 6a shows the configuration of this embodiment without a measurement object 9. Either the multiple measuring devices are arranged in a separate measuring chamber, or, as shown in FIG. 4, the plurality of measuring devices 1, 11 are arranged next to one another within an intermediate module 12, or the plurality of measuring devices 11 are arranged in rows next to one another in and next to a chamber valve 14.

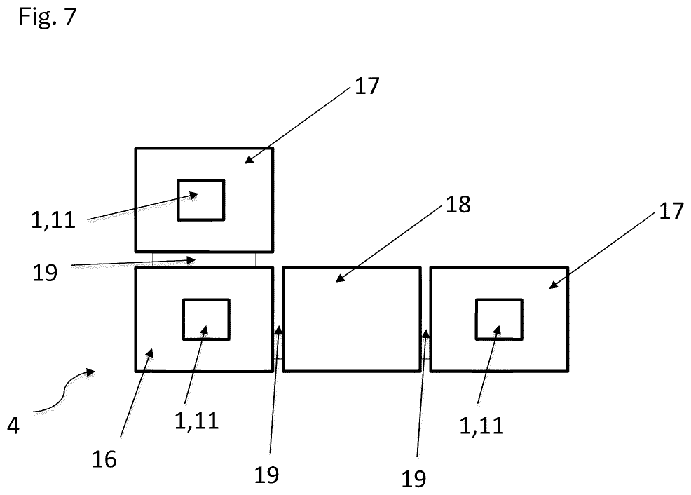

FIG. 7 schematically shows a vacuum chamber or vacuum system 4 with different parts such as a process chamber 16, a handling chamber 18, and a separate measurement chamber 17, which are connected over a handling system 19. Furthermore, FIG. 7 shows different possible positions of the measuring device 1, 11 according to different embodiments of the invention described above.

### LIST OF REFERENCE SIGNS

1 Measuring device as a capsule
2 Transmitting and/or receiving coil in the sensor head, inductive sensor
3 Signal amplifier and signal processing unit
4 Vacuum chamber
5 Vacuum region
6 Atmospheric side
7 Flange or seal
8 Chamber wall
9 Measurement object to be measured, e.g. wafer
10 Capsule
11 Measuring device as an encased transmitting and receiving coil
12 Intermediate module
13 -
14 Chamber valve to a process chamber
15 Connection to signal amplification and signal processing unit
16 Process chamber
17 Separate measuring chamber
18 Handling chamber
19 Handling system

What is claimed is:

1. A measuring device for characterizing a measurement object in a vacuum, the measuring device comprising:
an inductive sensor including
a transmitting coil for generating an alternating electromagnetic field, and
a receiving coil for detecting an impedance change; and
a signal amplifier and/or a signal processing unit for evaluating measurement signals,
wherein the transmitting coil, the receiving coil, and the signal amplifier and/or the signal processing unit are arranged outside the vacuum,
wherein the transmitting coil and the receiving coil are configured to each be inserted into a respective capsule,
wherein each respective capsule is an integral part of a chamber wall of a vacuum chamber and projects into the vacuum, and
wherein the chamber wall separates the vacuum from an atmospheric side.

2. The measuring device according to claim 1, wherein
the transmitting coil is positioned above the measurement object and the receiving coil is positioned below the measurement object or
the transmitting coil is positioned below the measurement object and the receiving coil is positioned above the measurement object.

3. The measuring device according to claim 1,
wherein the measurement object is measured contactlessly,
wherein the inductive sensor measures the measurement object in electromagnetic transmission during a movement of the measurement object past the inductive sensor and/or statically on the measurement object.

4. The measuring device according to claim 1,
wherein the measurement object is guided past each respective capsule at a distance of 2 to 25 mm.

5. The measuring device according to claim 1,
wherein each respective capsule is made of a non-conductive and non-outgassing material.

6. The measuring device according to claim 1,
wherein the measuring device is arranged in a separate measuring chamber which can be connected to a handling chamber or to a process chamber in which the measurement object can be processed, via the respective capsules as part of the measuring device, and the measurement object can be transferred from the handling chamber or the process chamber into the separate measuring chamber via a handling system without interrupting the vacuum and can be measured there.

7. The measuring device according to claim 1,
wherein the measuring device is formed in an intermediate module that is 5 to 75 mm thick and arranged between a process chamber and a handling region,
wherein the intermediate module is formed as a frame that is 220 mm to 4500 mm wide,
wherein the transmitting coil and the receiving coil of the measuring device are formed in the frame so that the measurement object can be moved past the transmitting coil and the receiving coil of the inductive sensor at a distance of 2 mm to 100 mm during a transfer into or out of the process chamber into the handling region.

8. The measuring device according to claim 1,
wherein the measuring device is arranged in an integrated manner in or on a chamber valve which separates a process chamber and a handling region.

9. A system, comprising more than one measuring device according to claim 1 next to one another in a row.

10. The measuring device according to claim 1,
further comprising a temperature sensor arranged in an immediate vicinity of the inductive sensor,
wherein values of a layer resistance of the measurement object can be determined by the inductive sensor, and temperature values of the measurement object can be determined by the temperature sensor,
wherein a prediction of a cold resistance of the measurement object can be made from determined values of the layer resistance and the temperature values of the measurement object, and
wherein temperature-independent layer thicknesses of the measurement object can be calculated.

11. A measuring device for characterizing a measurement object in a vacuum, the measuring device comprising:
an inductive sensor including
a transmitting coil for generating an alternating electromagnetic field, and
a receiving coil for detecting an impedance change; and
a signal amplifier and/or a signal processing unit for evaluating measurement signals,
wherein the transmitting coil and the receiving coil are encased in a vacuum-compatible material and are arranged within the vacuum, and
wherein the signal amplifier and/or the signal processing unit are arranged outside the vacuum,
wherein the transmitting coil and the receiving coil are each connected to the signal amplifier and/or the signal processing unit on an atmospheric side via a flange or a seal through a chamber wall of a vacuum chamber, and
wherein the transmitting coil and the receiving coil are disposed at a spatial distance of 10 mm, from one another.

12. The measuring device according to claim 11, wherein
the transmitting coil is positioned above the measurement object and the receiving coil is positioned below the measurement object or
the transmitting coil is positioned below the measurement object and the receiving coil is positioned above the measurement object.

13. The measuring device according to claim 11,
wherein the measurement object is measured contactlessly,
wherein the inductive sensor measures the measurement object in electromagnetic transmission during a movement of the measurement object past the inductive sensor and/or statically on the measurement object.

14. The measuring device according to claim 11,
wherein the measurement object is guided past the transmitting coil and the receiving coil at a distance of 2 to 25 mm.

15. The measuring device according to claim 11,
wherein the vacuum-compatible material is non-conductive and non-outgassing.

16. The measuring device according to claim 11,
wherein the measuring device is arranged in a separate measuring chamber which can be connected to a handling chamber or to a process chamber in which the measurement object can be processed, via a flange or a seal, and the measurement object can be transferred from the handling chamber or the process chamber into the separate measuring chamber via a handling system without interrupting the vacuum and can be measured there.

17. The measuring device according to claim 11,
wherein the measuring device is formed in an intermediate module that is 5 to 75 mm thick and disposed between a process chamber and a handling region,
wherein the intermediate module is formed as a frame that is 220 mm to 4500 mm wide,
wherein the transmitting coil and the receiving coil of the measuring device are formed in the frame so that the measurement object can be moved past the transmitting coil and the receiving coil of the inductive sensor at a distance of 2 mm to 100 mm during a transfer into or out of the process chamber into the handling region.

18. The measuring device according to claim 11,
wherein the measuring device is arranged in an integrated manner in or on a chamber valve which separates a process chamber and a handling region.

19. A system, comprising more than one measuring device according to claim 11 formed next to one another in a row.

20. The measuring device according to claim 11,
further comprising a temperature sensor arranged in an immediate vicinity of the inductive sensor,
wherein values of a layer resistance of the measurement object can be determined by the inductive sensor, and temperature values of the measurement object can be determined by the temperature sensor,
wherein a prediction of a cold resistance of the measurement object can be made from a determined values of the layer resistance and the temperature values of the measurement object, and
wherein temperature-independent layer thicknesses of the measurement object can be calculated.
